(19) United States
(12) Patent Application Publication
(10) Pub. No.: US 2003/0055951 A1
(43) Pub. Date: Mar. 20, 2003

(54) Products, apparatus and methods for handling computer software/hardware messages

(76) Inventor: Emilio F. Chemali, Kingwood, TX (US)

Correspondence Address: J. M. (Mark) Gilbreth, GILBRETH & ASSOCIATES, P. C., P.O. Box 2428, Bellaire, TX, 77420-2428, US

(21) Appl. No.: 09/920,699

(22) Filed: Aug. 1, 2001

(51) Int. Cl. G06F 15/173

(52) U.S. Cl. 709/224

(57) ABSTRACT

Products, apparatus and methods for monitoring Application Programming Interface (“API”) Messaging data from a number of software applications running on a network, providing realtime access to the data, realtime warnings and/or instructions from the evaluation of such data, and storing such data for later evaluation.

### BACKGROUND OF THE INVENTION

1. Field of the Invention

The present invention relates to products, apparatus and methods for use with computer software and hardware and/or hardware. In another aspect, the present invention relates to products, apparatus and methods for handling computer hardware/software Interface Messaging data. In even another aspect, the present invention relates to products, apparatus and methods for handling computer hardware/software Interface Messaging data to provide information on which software applications are over or under utilizing Messaging, or otherwise not properly utilizing Messaging. In still another aspect, the present invention relates to products, apparatus and methods for handling Application Program Interface Messaging data to provide information on which software applications are over or under utilizing Messaging, or otherwise not properly utilizing Messaging.

2. Description of the Related Art

Many of the various commercially available software applications utilize Messaging Application Programming Interfaces (“API”) (sometimes also known as Messaging Oriented Middleware, “MOM”) to communicate between various software applications residing across multiple hardware platforms. These Messaging API's are generally communicated by Publish/Subscribe (i.e., send/receive), Request/Reply, and Message Queuing (i.e., the messages are queued by the publisher and consumed by the requester).

This Messaging is used to integrate various software applications on different hardware platforms, operating systems, and programming languages to enable them to exchange data.

APIs are designed to meet objectives of source code portability or binary portability. In the former case, the source code reflects the specification of the API, but after compilation portability is usually lost and the resulting binary is specific to the particular platform for which it is compiled. In the latter case, the binary itself is portable between a number of platforms.

It is this binary portability that is the basis of the considerable variety of commercially available shrink-wrapped personal computer (“PC”) applications.

On a busy network, there may be hundreds of PC's, each with multiple software applications that are Publishing and Subscribing a vary large volume of Messaging data. While a network administrator may be able to manually process smaller volumes of data, the administrator will be unable to process a large volume of Messaging data in a quick, accurate and efficient manner, and consequently will not be able to easily determine which software applications are over or under utilizing Messaging, or otherwise not properly utilizing Messaging. In fact, in some instances, very large volumes of data are not humanly possible to analyze.

Thus, there still exists a need in the art for products, apparatus and methods for handling Messaging data.

There is another need in the art for products, apparatus and methods for handling Messaging data, which do not suffer from the disadvantages of the prior art products, apparatus and methods.

There is even another need in the art for products, apparatus and methods for handling Messaging data, to provide information on which determine which software applications are over or under utilizing Messaging, or otherwise not properly utilizing Messaging.

There is still another need in the art for products, apparatus and methods for handling Messaging data to provide realtime warnings and/or instructions regarding the operation of the computer system.

These and other needs in the art will become apparent to those of skill in the art upon review of this specification, including its drawings and claims.

### SUMMARY OF THE INVENTION

It is an object of the present invention to provide for products, apparatus and methods for handling Messaging data.

It is another object of the present invention to provide for products, apparatus and methods for handling Messaging data, which do not suffer from the disadvantages of the prior art products, apparatus and methods.

It is even another object of the present invention to provide for products, apparatus and methods for handling Messaging data to provide information on which determine which software applications are over or under utilizing Messaging, or otherwise not properly utilizing Messaging.

It is still another object of the present invention to provide for products, apparatus and methods for handling Messaging data and provide realtime signals, for example warnings and/or instructions regarding the operation of the computer system.

These objects are merely a listing of some of the objects of the present invention, and are not intended and do not limit the scope of the present invention. These and other objects of the present invention will become apparent to those of skill in the art upon review of this specification, including its drawings and claims.

According to one non-limiting embodiment of the present invention, there is provided a method for monitoring a computer network, for a network comprising at least two computers in communication with each other, and with each computer executing at least one software program publishing messages. The method generally includes counting, starting at a first time, messages published in a first time period to provide a first count, and then comparing the first count to signaling criteria. The method further optionally includes generating a signal dependant on the comparison.

According to another non-limiting embodiment of the present invention, there is provided a system for gathering data from a computer network comprising at least two computers in communication with each other, and with each computer executing at least one software program publishing messages, the system comprising a computer in communication with the network and comprising software that when executed instruct the system to count, starting at a first time, messages published in a first time period to provide a first count, and compare the first count to signaling criteria. Optionally, the system further comprises instructions that when executed by a computer instruct the computer to generate a signal dependant on the comparison step.

According to even another non-limiting embodiment of the present invention, there is provided a computer-readable storage medium having stored thereon a plurality of instructions for gathering data from a computer network comprising at least two computers in communication with each other, and with each computer executing at least one software program publishing messages, said instructions that when executed by a computer instruct the computer to count, starting at a first time, messages published in a first time period to provide a first count, and compare the first count to signaling criteria. Optionally, the system further comprises instructions that when executed by a computer instruct the computer to generate a signal dependent on the comparison step.

According to still another non-limiting embodiment of the present invention, there is provided a propagated signal comprising a plurality of instructions for gathering data from a computer network comprising at least two computers in communication with each other, and with each computer executing at least one software program publishing messages, said instructions that when executed by a computer instruct the computer to count, starting at a first time, messages published in a first time period to provide a first count, and compare the first count to signaling criteria. Optionally, the system further comprises instructions that when executed by a computer instruct the computer to generate a signal dependant on the comparison step.

According to yet another non-limiting embodiment of the present invention, there is provided a method for gathering data from a computer network comprising at least two computers in communication with each other, and with each computer executing at least one software program publishing messages, the method comprises the step of monitoring the messages, the step of comparing the messages to signaling criteria, and the step of generating a signal dependent upon the comparison step.

According to even still another non-limiting embodiment of the present invention, there is provided a system for gathering data from a computer network comprising at least two computers in communication with each other, and with each computer executing at least one software program publishing messages, the system comprising a computer in communication with the network and comprising software that when executed instruct the system to monitor the messages, compare the messages to signaling criteria, and then generate a signal dependent upon the comparison.

According to even yet another non-limiting embodiment of the present invention, there is provided a computer-readable storage medium having stored thereon a plurality of instructions for gathering data from a computer network comprising at least two computers in communication with each other, and with each computer executing at least one software program publishing messages, said instructions that when executed by a computer instruct the computer to monitor the messages, compare the messages to signaling criteria, and generate a signal dependent upon the comparison.

According to still even another non-limiting embodiment of the present invention, there is provided a propagated signal comprising a plurality of instructions for gathering data from a computer network comprising at least two computers in communication with each other, and with each computer executing at least one software program publishing messages, said instructions that when executed by a computer instruct the computer to monitor the messages, compare the messages to signaling criteria, and generate a signal dependent upon the comparison.

According to still yet another non-limiting embodiment of the present invention, there is provided a method for gathering data from a computer network comprising at least two computers in communication with each other, and with each computer executing at least one software program publishing machine specific messages, the method comprises monitoring the machine specific messages and extracting data from the messages. The method optionally further comprises comparing the data to criteria, and generating a signal dependent upon the comparing step.

According to yet even another non-limiting embodiment of the present invention, there is provided a system for gathering data from a computer network comprising at least two computers in communication with each other, and with each computer executing at least one software program publishing messages, the system comprising a computer in communication with the network and comprising software that when executed instruct the system to monitor the machine specific messages, and extract data from the messages. The instructions may further includes instructions to compare the data to criteria, and generate a signal dependent upon the comparing step.

According to yet still another non-limiting embodiment of the present invention, there is provided a computer-readable storage medium having stored thereon a plurality of instructions for gathering data from a computer network comprising at least two computers in communication with each other, and with each computer executing at least one software program publishing messages, said instructions that when executed by a computer instruct the computer to monitor the machine specific messages, and extract data from the messages. The instructions may further includes instructions to compare the data to criteria, and generate a signal dependent upon the comparing step.

According to even still yet another non-limiting embodiment of the present invention, there is provided a propagated signal comprising a plurality of instructions for gathering data from a computer network comprising at least two computers in communication with each other, and with each computer executing at least one software program publishing messages, said instructions that when executed by a computer instruct the computer to monitor the machine specific messages, and extract data from the messages. The instructions may further includes instructions to compare the data to criteria, and generate a signal dependent upon the comparing step.

According to even yet still another non-limiting embodiment of the present invention, there is provided a method for gathering data from a computer network comprising at least two computers in communication with each other, and with each computer executing at least one software program publishing messages having a subject field, the method comprises, the step of monitoring the messages, the step of determining if the message subject field already exists in a current listing of subjects, and if so then return to monitoring, and the step of determining if the message subject does not exist in the listing of subject, if not then adding the message subject to the listing, and then return to monitoring.

According to still even yet another non-limiting embodiment of the present invention, there is provided a system for gathering data from a computer network comprising at least two computers in communication with each other, and with each computer executing at least one software program publishing messages, the system comprising a computer in communication with the network and comprising software that when executed instruct the system to monitor the messages, to determine if the message subject field already exists in a current listing of subjects, and if so then return to monitoring, and to determine if the message subject does not exist in the listing of subject, and if not, then add the message subject to the listing, and then return to monitoring.

According to still yet even another non-limiting embodiment of the present invention, there is provided a computer-readable storage medium having stored thereon a plurality of instructions for gathering data from a computer network comprising at least two computers in communication with each other, and with each computer executing at least one software program publishing messages, said instructions that when executed by a computer instruct the computer to monitor the messages, to determine if the message subject field already exists in a current listing of subjects, and if so then return to monitoring, and to determine if the message subject does not exist in the listing of subject, and if not, then add the message subject to the listing, and then return to monitoring.

According to yet even still another non-limiting embodiment of the present invention, there is provided a propagated signal comprising a plurality of instructions for gathering data from a computer network comprising at least two computers in communication with each other, and with each computer executing at least one software program publishing messages, said instructions that when executed by a computer instruct the computer to monitor the messages, to determine if the message subject field already exists in a current listing of subjects, and if so then return to monitoring, and to determine if the message subject does not exist in the listing of subject, and if not, then add the message subject to the listing, and then return to monitoring.

According to yet still even another non-limiting embodiment of the present invention, there is provided a method for gathering data from a computer network comprising at least two computers in communication with each other, and with each computer executing at least one software program publishing messages, the method comprises monitoring a message coming from a messaging computer, and identifying the messaging computer. Optionally, the “identifying” comprises the steps of (i) determining a message header; (ii) determining a message footer; and (iii) subtracting the header and footer from the message to provide the messaging computer.

According to another non-limiting embodiment of the present invention, there is provided a system for gathering data from a computer network comprising at least two computers in communication with each other, and with each computer executing at least one software program publishing messages, the system comprising a computer in communication with the network and comprising software that when executed instruct the system to monitor a message coming from a messaging computer, and to identify the messaging computer. Optionally, the “identifying” instructions comprise software that when executed instruct the system to (i) determine a message header; (ii) determine a message footer; and (iii) subtract the header and footer from the message to provide the messaging computer.

According to another non-limiting embodiment of the present invention, there is provided a computer-readable storage medium having stored thereon a plurality of instructions for gathering data from a computer network comprising at least two computers in communication with each other, and with each computer executing at least one software program publishing messages, said instructions that when executed by a computer instruct the computer to monitor a message coming from a messaging computer, and to identify the messaging computer. Optionally, the “identifying” instructions comprise software that when executed instruct the system to (i) determine a message header; (ii) determine a message footer; and (iii) subtract the header and footer from the message to provide the messaging computer.

According to even another non-limiting embodiment of the present invention, there is provided a propagated signal comprising a plurality of instructions for gathering data from a computer network comprising at least two computers in communication with each other, and with each computer executing at least one software program publishing messages, said instructions that when executed by a computer instruct the computer to monitor a message coming from a messaging computer, and to identify the messaging computer. Optionally, the “identifying” instructions comprise software that when executed instruct the system to (i) determine a message header; (ii) determine a message footer; and (iii) subtract the header and footer from the message to provide the messaging computer.

These embodiments are merely a listing of some of the objects of the present invention, and are not intended and do not limit the scope of the present invention. These and other embodiments of the present invention will become apparent to those of skill in the art upon review of this specification, including its drawings and claims.

### BRIEF DESCRIPTION OF THE DRAWINGS

FIG. 1 is a high level schematic representation of a networked system 100, showing API Messaging flow between various software applications 120,message logger 110 of the present invention, database 125 and analysis computer 130.

FIG. 2 is a schematic representation of a portion of a networked system 100 for making sales, showing a “Deal Entry” software application 120A, a “Billing” software application 120B, a “Shipping and Distribution” software application 120C, messager logger 110 of the present invention, all in communication via a local area network (“LAN”) connection 121.

FIG. 3 is a schematic representation of one embodiment of message logger 110 of the present invention, representing message logger 110 as various components, specifically, message logger capture agent 110A, message logger network monitor agent 110B, message logger storm monitor agent 110C, message logger alert monitor agent 110D, message logger new subject monitor agent 110E, and message logger message tracker agent 110F.

FIG. 4 is a flow chart diagram of one embodiment of the message logger method 200 of the present invention, showing the high level logic for message logger capture method 210A, message logger network monitor method 210B, message logger storm monitor method 210C, message logger alert monitor method 210D, message logger new subject monitor method 210E, and message logger message tracker method 210F.

FIG. 5 is a detailed process flowchart showing details for message logger capture system/method 110A/210A, message logger network monitor system/method 110B/210B, and message logger storm monitor system/method 110C/210C.

FIG. 6 is a detailed process flowchart showing details for message logger new subject monitor system/method 110E/210E.

FIG. 7 is a detailed process flowchart showing details for message logger alert monitor system/method 110D/210D.

FIG. 8 is a detailed process flowchart showing details for message logger message tracker system/method 110F/210F.

FIG. 9 is a detailed process flowchart for extraction step 455 of FIG. 8.

### DETAILED DESCRIPTION OF THE INVENTION

The present invention provides products, apparatus and methods to monitor Messaging data, preferably API Messaging data, and optionally to store and/or provide statistical information regarding such stored data.

While the present invention is illustrated mainly by reference to the preferred API Messaging data, the present invention is not to be so limited and is believed to find utility with any type of computer hardware or software messaging interface data, including messaging interface data for a Human/Computer Interface, that is, an interface of a system at which physical interactions take place between a human being and the system, for an Information Services Interface, that is, an interface of a system at which interactions take place with external persistent storage (e.g. removable disc storage), and for a Communications Services Interface, that is, an interface of a system at which interactions take place with entities external to the system, such as external data transport facilities and functions in other systems.

Non-limiting examples of Application Programming Interface messaging data suitable for use with the present invention include: Computer Graphics Interface (CGI); Common Object Request Broker Architecture (CORBA); Distributed Computing Environment (DCE); Document Object Model (DOM); Distributed Systems Management (DSM); Forms Interface Management System (FIMS); Geometric Programming Interface; Interface Definition Language (IDL); Internet-related APIs; IRDS Services Interface; Java APIs; Java Messaging Service (“JMS”); Java Smart Card API; Open Document Management API (ODMA); OSI Application Program Interfaces (OSI-API); Portable Common Tool Environment (PCTE) Application Programmer's Interface; Portable Operating Systems Interface (POSIX); Protocol Independent Interfaces (PII); Simple Object Access Protocol (SOAP); Speech Translation APIs; SQL Call-Level Interface (SQL/CLI); Toolkit Without An Important Name (TWAIN); and Universal Description, Discovery & Integration (UDDI).

The present invention will now be described by reference to the drawings.

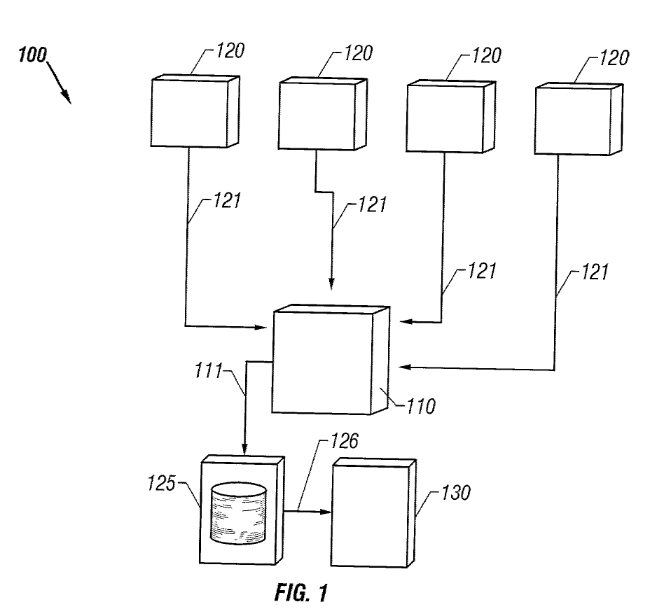

Referring to FIG. 1, there is provided a high level schematic representation of networked system 100, showing API Messaging flow between various software applications 120, message logger 110 of the present invention, database 125 and computer 130. Of course, database 125 could optionally reside on computer 130. Communication links 121 transport Messaging data from the various software applications 120 to message logger 110 of the present invention. While this data may be displayed in real time, it is most conveniently provided by communication link 111 to database 125. An analysis computer 130, may conveniently access database 125 via communication link 126 to obtain raw data and/or calculate any desired information regarding the stored Messaging data. Here, and throughout, it should be understood that a “communication link” may be any suitable apparatus and/or method for providing digital communication, including hardwire, wireless, and a combination thereof, and may be by a dedicated connection, dial-up, or any other means as are known to those of skill in the art.

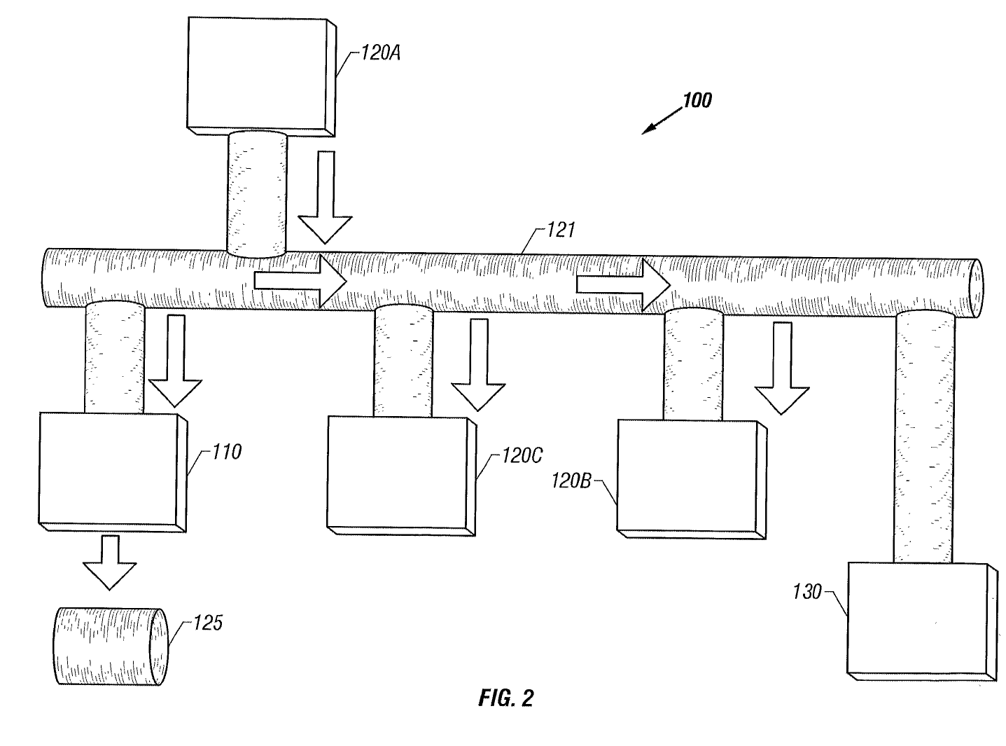

Referring additionally to FIG. 2, there is shown a schematic representation of a portion of a networked system 100 for conducting a sales transaction, showing “Deal Entry” software application 120A, “Billing” software application 120B, “Shipping and Distribution” software application 120C, and message logger 110 of the present invention, all in communication via a local area network (“LAN”) connection 121.

The operation of the various software applications 120A, 120B, 120C, and their API messaging are well known in the art. In general, upon receipt of a new order, the originating application, i.e., “Deal Entry” software application 120A, processes the new order. Upon processing this new order, “Deal Entry” software application 120A Publishes a message to “Billing” software application 120C and “Shipping and Distribution” software application 120B, by Publishing an API Message that contains among other data the details regarding the order. The “Billing” software application 120C and “Shipping and Distribution” software application 120E Subscribe to the API Messaging from “Deal Entry” software application 120A. The “Billing” software application 120C and “Shipping and Distribution” software application 120B, have been provided with software instructions from the “Deal Entry” software vendor to allow decoding of the Messaging to decode information concerning the new deal.

According to the present invention, message logger 110 and message logger method 200 gather this API Messaging data, and optionally may record such data in database 125, and/or may generate a signal depending upon the raw Messaging data, or the analysis of the Messaging data. Here and throughout, a signal may include, but not be limited to, a warning or other communication to a particular user perhaps in the form of an email, a screen display, a page, or a voice mail, may also include an instruction or other communication to a particular software program perhaps in the form of a Message, an email, an API Method Call, and finally may also include an instruction or other communication to a particular hardware perhaps in the form of a Message, an API Method Call, or Simple Network Management Protocol (“SNMP”).

A computer 130 is provided as a user interface to allow convenient access to database 125 in order to obtain raw data and/or calculate any desired information regarding the stored Messaging data. Optionally, computer 130 may be tasked to analyze the Messaging data database 125, and may also generate a signal depending upon the raw Messaging data, or the analysis of the Messaging data.

Any number of database reporting tools, such as the commercially available Microsoft Access, Crystal Reports, Oracle Reports, Business Objects Reports, Corel Paradox, can be customized to allow a user to run predefined reports and view data.

According to a preferred embodiment of the present invention, computer 130 may comprise a web server from which users, software or hardware can request information regarding the Messaging data. The requesting workstation would utilize a web browser, non-limiting commercially available examples include Microsoft Internet Explorer or Netscape Navigator, to retrieve the reports from data base 125. via the web server using any suitable data transfer protocol, a non-limiting example would include HTTP. Web server programming languages, such as Active Server Pages (“ASP”) or Java Server Pages (“JSP”), may be utilized to retrieve data from database 125, apply statistics to the data, and display the data and statistical results on a web page, which page may be refreshed at any desired refresh rate.

In the embodiment as illustrated in the drawings, message logger 110 includes 6 components. Of course, it should be understood that the present invention is not to be so limited, and could include more or less than 6 components, provided that the desired functions are carried out.

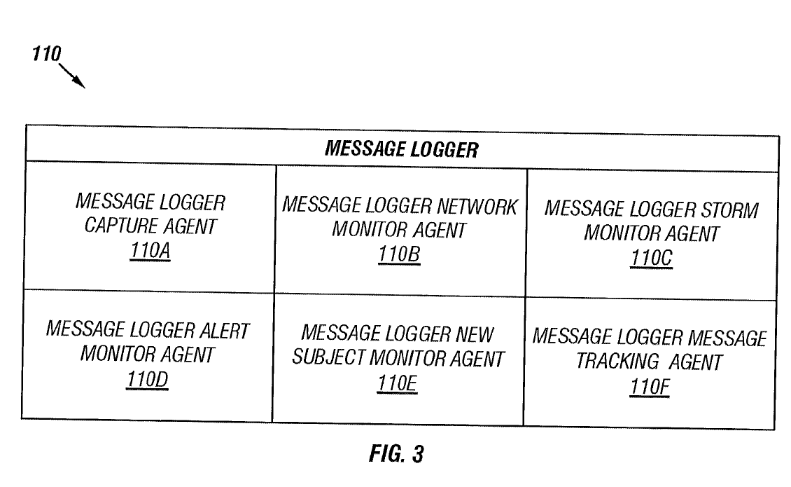

Referring additionally to FIG. 3, there is provided a schematic representation of one embodiment of message logger 110 of the present invention, representing message logger 110 as various components or “agents”, specifically, message logger capture agent 110A, message logger network monitor agent 110B, message logger storm monitor agent 110C, message logger alert monitor agent 110D, message logger new subject monitor agent 110E, and message logger message tracker agent 110F.

For the embodiment as shown, the various components are described in detail below.

Message logger capture agent 110A, will register itself as a listener for all vendor specific messaging events on the network. Once a message is received then certain desired data, as a non-limiting example, the message subject, the message date/time, the message size and/or the message source, is extracted and saved as a unique record in database 125.

Message logger network monitor agent 110B registers itself as a listener for all vendor specific messaging events that identify the machines on the network which are publishing or subscribing to messages. Non-limiting examples of information for which the network monitor agent 110B keeps track includes: machine name; machine IP address; machine operating system; number of messages sent/received; number of packets sent/received; version of the vendor messaging software; machine uptime; and/or number of error messages. This information is then saved on database 125 for the purpose of maintaining a historical trend of each machines behavior on the network.

Message logger storm (a “storm” refers to a heavy volume of messages, that is, “heavy” for that particular network system) monitor agent 110C registers itself as a listener for all vendor specific messaging events on the network to count messages per some unit of time to obtain a “message velocity” (i.e., number of messages/time). A “message acceleration” (i.e., change of message velocity/time) can be calculated by determining the difference between message velocities at two different times per the time difference. This information may be used in a near real-time manner to manage the system depending upon the message velocity, the message acceleration and/or a threshold value for velocity. Of course, a number of threshold values may be utilized to create different operating zones for which signals are generated.

It should be understood that a message velocity, message acceleration, or any other parameter or statistic can be determined for almost any desired subset of the overall network, for example, for the overall network, for a particular software application or group of software applications, for a particular piece of hardware or group of hardware, for a particular user or group of users, for a particular software application or group of software applications being used by a particular user or group of users, or any other conceivable criteria desired to be monitored.

Alternatively, this data can be stored on database 125 for the purpose of gathering information on processes which can be optimized to reduce the rate at which they publish, reduce messages which they agree to receive, or perhaps schedule high message rate applications, thereby allowing for better performance and less network impact.

For example, if a system is operating near its threshold maximum messaging rate (above which it will risk system failure), should message logger recognize an application starting up which historically operates at a messaging rate that will now push the system over the threshold, then a signal can be generated.

As another example, if the messaging acceleration (in view of the current messaging velocity) is such to anticipate that exceeding the threshold is relatively imminent, then a signal can also be generated.

As even another example, statistical prediction methods, for example time series analysis methods or least squares fit thru the historical data, can be used to provide a real-time and on-going prediction of message velocity to assist in operation of the network. It is envisioned that a graphical display, with perhaps a prominent horizontal line representing the “maximum,” and real-time plotting of the messaging velocity, would provide a quick visual indication of the messaging velocity relative the maximum. Optionally, a “predicted” velocity curve could be displayed, providing an indication of the predicted velocity relative the maximum.

As still another example, any messaging parameter or statistic, which appears out of the ordinary (when compared to the expected or historical data), can be used as a warning to further investigate the operation of the network for some sort of operation problem, or perhaps even unauthorized activity (such as hacking or running of destructive or disrupting software). For example, high volume messaging activity from commodities trading software during a time (i.e., weekend or evening) of normally low volume).

Message logger alert monitor agent 110D registers itself as listener for all vendor specific messaging events on the network. This component has a database of user defined criteria. If alert monitor agent 110D detects a network event or messages which matches the user defined criteria, it then generates a signal corresponding to such criteria.

Message logger new subject monitor agent 110E registers itself as a listener for all vendor specific messaging events on the network. The new subject monitor agent 110E will send a signal if a new subject has been detected on the network, with the signal indicative of the new subject. This information is useful to manage which messages are valid on the network and which messages are not valid. With this information the network administrator can then track where the message originated and verify its validity.

Message logger message tracker agent 110F registers itself as a listener for all vendor specific messaging events on the network. Message tracker 110F tracks the machine name and IP address from which the messages originate. This is useful since some vendors provide a type of messaging known as “anonymous messaging” where the message is published from an unknown source.

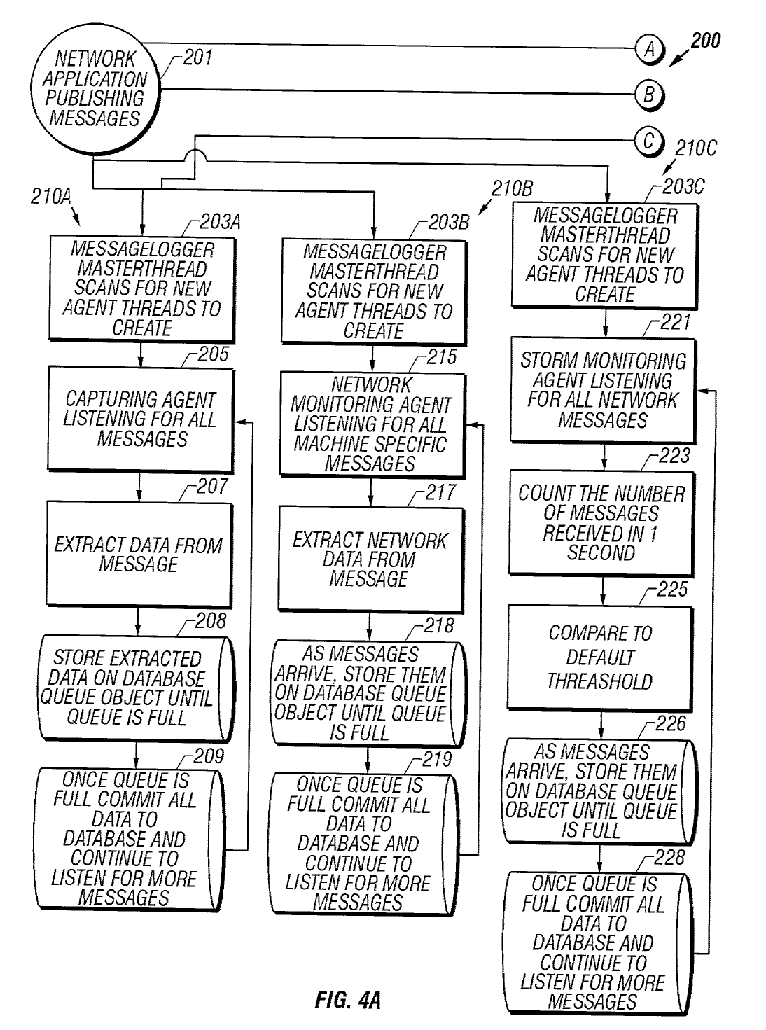

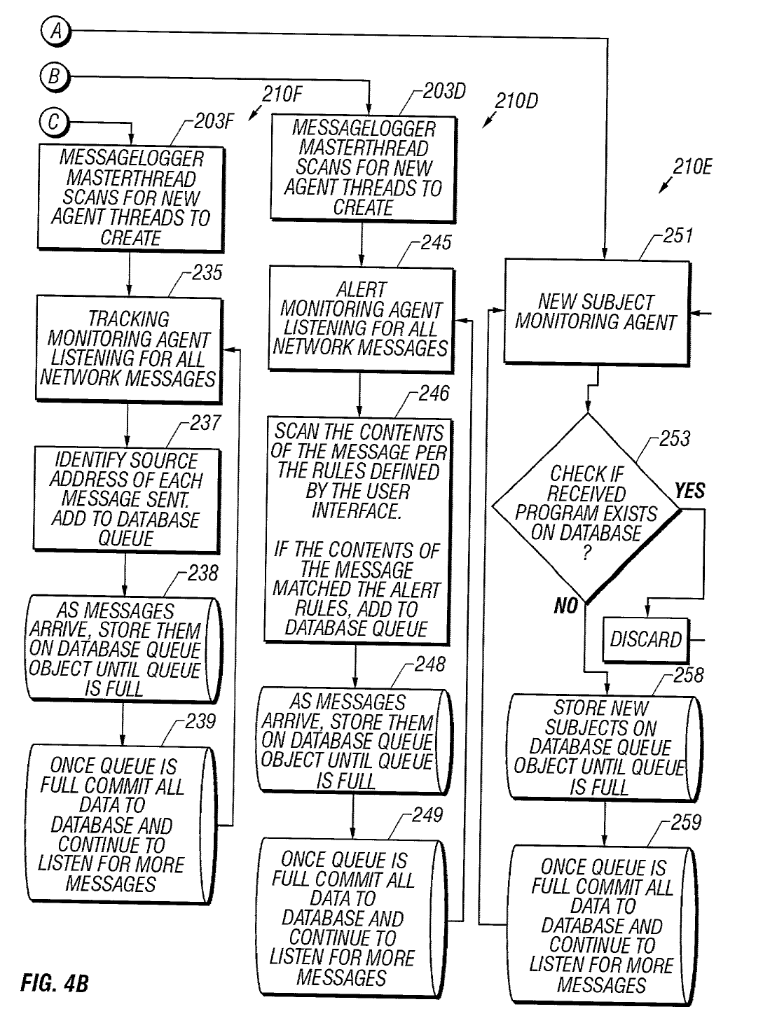

Referring additionally to FIG. 4, there is provided a flow chart diagram of one embodiment of the message logger method 200 of the present invention, showing the high level logic for message logger capture method 210A, message logger network monitor method 210B, message logger storm monitor method 210C, message logger alert monitor method 210D, message logger new subject monitor method 210E, and message logger message tracker method 210F. The various embodiments and features that have been discussed above with respect to message logger 110 are considered to be applicable for and may be carried out by logger method 200. Likewise, any embodiments and features of logger method 200 are believed to be implementable by message logger 110.

Publication of messages 201 occurs when an application publishes a Message using the vendor specific API.

Software application monitoring step 203A, monitors for configuration changes in the network, such as the addition of a new software application, or the modification of an existing software application. A new capturing agent “thread”, that is, a set of computer instructions, is created for each new or modified software instruction found. For the capturing agent method 210A as shown in FIG. 4, the capturing agent thread will comprise steps 205, 207, 208, and 209.

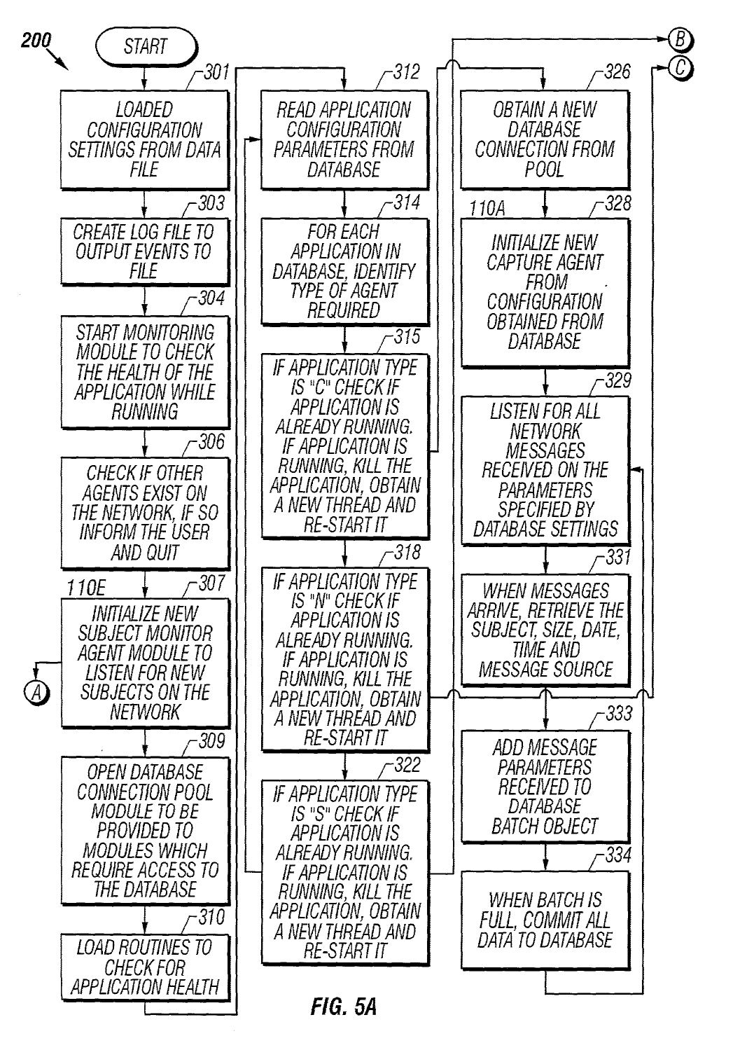

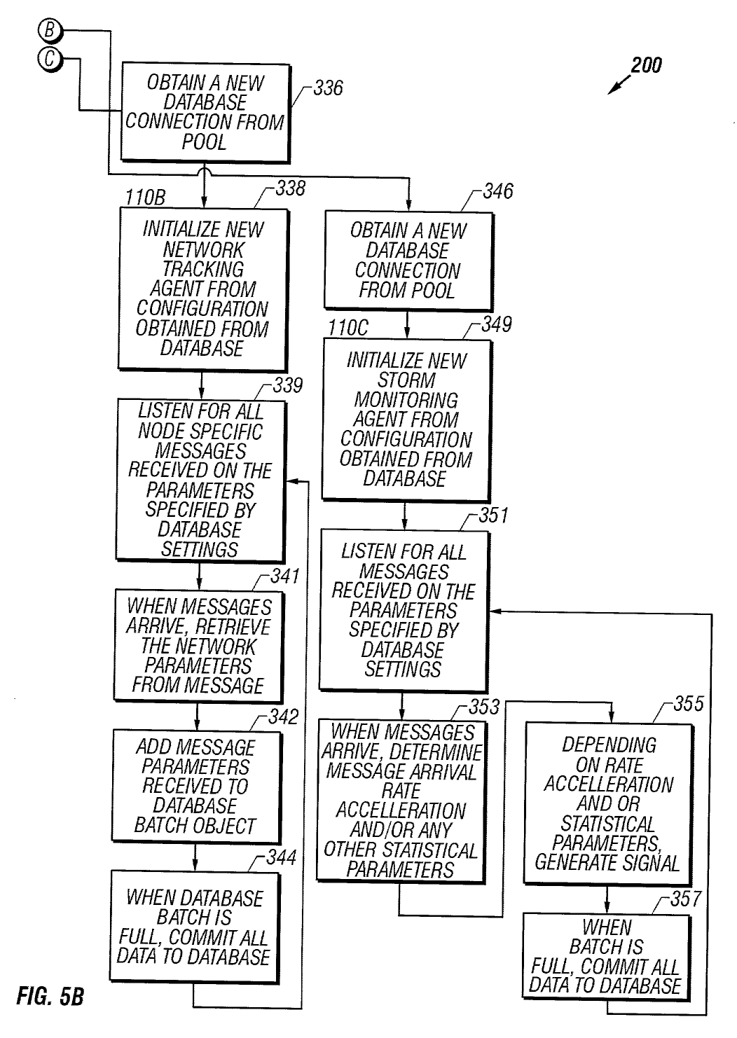

For the embodiment as shown in FIG. 4, each of the methods 210A, 210B, 210C, 210D and 210F, have their own thread creation functions 203A, 203B, 203C, 203D and 203F, respectively. However, it should be noted that alternative embodiments are considered in which one or more of the methods could share a common thread creation function. For example, in FIG. 5, methods 210A, 210B and 210C each share a common thread creation function.

In the practice of the present invention, each software application will be monitored by at least one of methods 210A, 210B, 210C, 210D and 210F. Each software application will require its own thread of the methods which are monitoring it. Thus, there most likely will be multiple threads running for each of the methods 210A, 210B, 210C, 210D and 210F. If should be understood that new subject monitoring method 210E requires only one thread, and is generally not running in multiple copies.

For message logger capture agent method 210A, capture agent monitoring step 205, listens for all messages, with data extraction step 207 extracting data from the API Message subject header. Because writing to a database is sometimes slow and inefficient, database queue step 208 stores this extracted data on a database queue until the queue is full. In database step 209, once the queue is full, the queued data is then quickly transferred to a database. Of course, for both this component and other components, it should be understood that data could be written directly to a database rather than first to a queue.

Regarding message logger network monitoring method 210B, network agent monitoring step 215 listens for all machine specific messages, with data extraction step 217 extracting data from the API Message subject header. In database queue step 218, this extracted data is stored on a database queue until the queue is full. In database step 219, once the queue is full, the queued data is then transferred to a database.

Regarding message logger storm monitoring method 210C, storm monitoring step 221 listens for all network messages, with message counting step 223 counting the number of messages received for a set counting period, which in the embodiment shown is 1 second, although any time period can be utilized. In comparison step 225, a signal is generated dependent upon the number of messages received and a user defined threshold, which signal may, comprise, as non-limiting examples, a warning or instructions, either to a system operator, directly to the network, to a user or a computer, to shut down, amend, change or otherwise curtail certain hardware/software operations. In database queue step 226, the extracted data and/or the received message values are stored on a database queue until the queue is full. In database step 228, once the queue is full, the queued data is then transferred to a database.

Regarding message logger tracking monitoring method 210F, monitoring step 235 listens for all network messages, with identification step 237 identifying the source address of each address sent and adding the source address to the database queue. In database queue step 238, this extracted data is stored on a database queue until the queue is full. In database step 239, once the queue is full, the queued data is then transferred to a database.

Regarding message logger alert monitoring method 210D, network agent monitoring step 245 listens for all network messages, with scanning step 246 scanning the messages to determine if the contents of the message matches user provided rules/criteria, and generating a signal if necessary. In database queue step 248, this extracted data is stored on a database queue until the queue is full. In database step 249, once the queue is full, the queued data is then transferred to a database.

The new subject monitoring method 210E checks to see if the message relates to a new software application not already being monitored by message logger system 110 and method 200. New subject monitoring step 251 listens for all network messages, with checking step 253 checking to see if the software program generating the message is already identified and being monitored. If not, database step 258 writes adds the software program name to the database.

Referring now to FIG. 5, there is provided a detailed process flowchart showing details for message logger capture method 210A, message logger network monitor method 210B, and message logger storm monitor method 210C.

A pre-initialization procedure includes configuration loading step 301, log file creation step 303, application health check step 304, and duplication check step 306. Each of the particular modules of message logger system 110 and method 200 require this pre-initialization procedure.

Configuration loading step 301 loads the configuration file with information necessary to carry out message logger 200. In the embodiment as illustrated, message logger 200 is configured using a properties file, and is a text based file which contains the required information parameters, which are dependent upon the particular network, and other factors. A non-limiting example of the types of required information that might be found in a properties file includes:

debug: if set to 1 will display additional process information on the console window useful for debugging;

logfile: if set to 1 will create a text log file and it will write all data displayed on the console window to this file, useful for debugging;

PoolRefreshThreadCheckInterval: default to 120000 used to manage database connection thread pool;

PoolInitialSize: default value set to 5, this will allocate 5 database connections from which all agents will be sharing database connectivity;

PoolMaxSize: default value 15, this is the maximum number of database connections that can be created;

PoolGrowBlock: default value 2, this is how many connections the databse pool will grow;

PoolCreateWaitTime: default value 2000, this is the delay time between connection creation;

dbmsDriver: JDBC driver class name for database connectivity;

dbmsURL: JDBC connection information for database connectivity;

dbmsType: type of databse to use for the pusposes of storing message information, these can be MSSQL for Microsoft SQL Server or Oracle8 for Oracle 8i

dbmsUID: user id to log on to database;

dbmsPWD: password to log on to databse;

agent_name: name assigned to the collection of message logger agents for the purpose of distinguish them from other agents on the network and to prevent having duplicate agents writing the same data to the database;

admin_network: administrative network parameter for the agent;

admin_service: administrative UDP service port for the agent: default to 7599

admin_daemon: TCP port number for administrative functions, typically set to the same value as admin_service;

smtp_from:email address in the form of xx@yy.zz;

smtp_to:email address in the form of xx@yy.zz;

smtp_host: SMTP host name;

MaxThreadCount: This parameter indicates the maximum number of instaces which can be created by the message logger agent. This is designed to prevent too many agents from starting and using up all the memory on the system;

NewSubjectSearchInterval: default value:5000, used to set the interval at which new subjects are checked for;

NewSubject_RV: default false. Used to ignore _RV.> messages during the new subject discovery process;

NewSubjectAlert:default false, used to send email if a new subject is detected;

StormThreashold: default 100, this is the minimum number of messages per second that can arrive to be considered a storm;

“vendor tool name”_service: used for Vendor supplied monitoring tool;

“vendor tool name”_network: used for Vendor supplied monitoring tool; and

“vendor tool names”_daemon: used for Vendor supplied monitoring tool.

Log file creation step 303 creates a new text file, overriding the existing one (if any), which file is used to copy the contents of the Console Screen into the file for the purposes of auditing the application activity in case the application is stopped.

Application health check step 304 creates an instance of the monitoring class, which is used to report the internal health of the target software application to be monitored. This is a way to enable the target software application to report its internal state.

Duplication check step 306 check if an identical message logger agent exists on the network. For example if this were initializing the “Storm Monitor,” it would check to see if another “Storm Montor” was monitoring the same target software application. It should be noted that another “Storm Monitor” could be operating provided it were monitoring a second software application. Duplication check step 306 sends a request to the network looking for a reply from other message logger agents. If other agents are found, the agent checks their machine name and IP address—continues if different, quits if there is a match. This mechanism is used to prevent duplicate agents from entering the same information on the database and therefore creating inaccurate statistics.

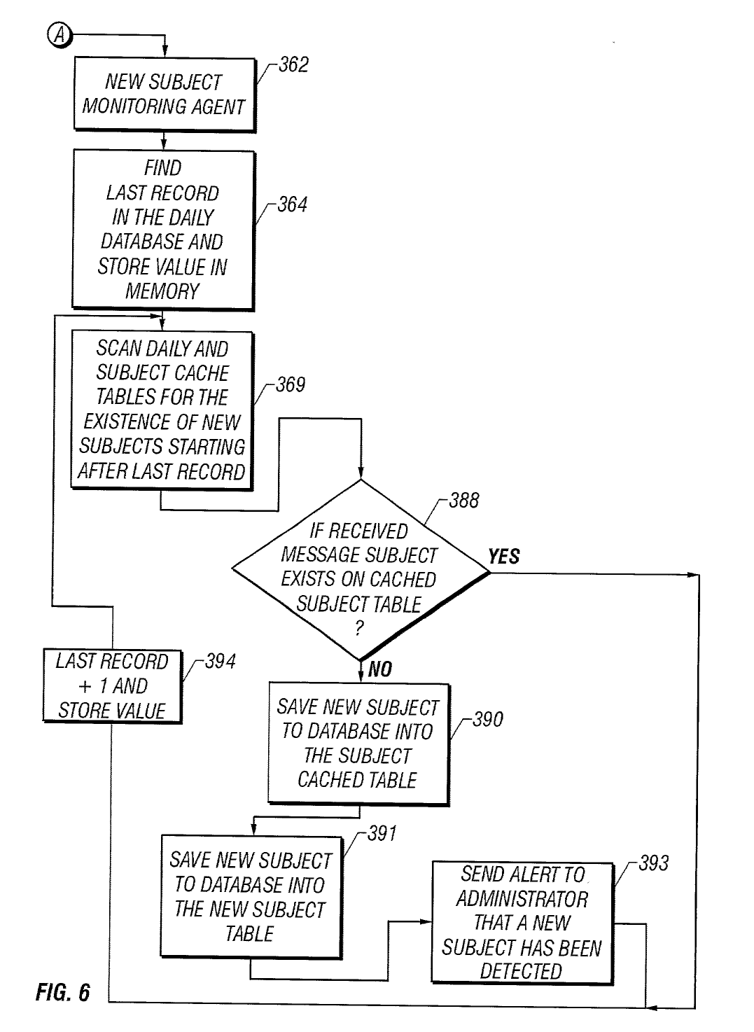

Initialize new subject monitor agent step 307 starts a new instance of new subject monitor system/method 110E/210E which look for new software applications for the interval specified in the properties file. If a new software application is detected, it is then stored on the database and the administrator is notified. More details regarding new subject monitor system/method 110E/210E is provided in FIG. 6 below.

Database connection pool step 309 creates a pool of database connections for all the message logger agents to share. This is a mechanism used to manage scalability of message logger 210 allowing recycle of database connections not in use. The parameters to configure the database connection pool are found on the properties file.

Message logger agent health check step 310 is a collection of 3 routines, which provide information about the internal state of the application.

GetStatus—returns 1 if everything is OK, 0 if there is something wrong;

GetVersion—returns the version of the Message logger application; and

Shutdown—Stops the application.

Read parameters step 312 checks the version of the message logger application against the version of the database. If the version doesn't match the user is informed and the program quits. The message logger application stores application related configuration information in the application table, which can be seen, on the database diagram. As non-limiting example, this information includes:

Application name: name of the app to be monitored

Service: UDP port to listen on

Network: network id to listen on

Environment: prod,test,dev, etc.

Las_update: last time record was updated

Type: N—Network, C—Capture, S—Storm

Active: 1 active, 0—inactive

Agent_name; name of agent to run this application monitor

Batch_commit_rate: how often to write/commit queue to database

Max_commit_time: max time to wait before committing queue to database.

Message logger type identification step 314 is used to limit the execution of the various message logger agents. Specifically, for the embodiment as shown FIG. 5, capture agent 110A, network agent 110B and storm agent 110C have been packaged together in one program. The user can be restricted to using only one or two of the agents by providing the appropriate values in the “application table.” For example, when the application table type entry shows “C” it will start only Capture agent 110A. As another example, when the application table type entry shows “CS” it will start only Capture agent 110A and Storm agent 110C. As a final example, when the application table type entry shows CSN it will start the Capture, Network and Storm agents. Of course, any suitable combination of message logger agents can be utilized.

The application master thread step 315 checks if the new agent type “C” is already monitoring an application in memory. Application master thread steps 318 and 322, likewise respectively check for agent types “N” and “S.” If an agent already exists, the master thread will attempt to kill it and then it will start a fresh copy with the latest updates. If the agent does not exists, and then a new copy, i.e. of all of the instructions of that particular message logger agent, will be created.

Message logger system/method 110/210 continually loops back through steps 312, 314, 315, 318 and 322, at a user defined frequency, which in the embodiment illustrated is 8 seconds, and spans “threads” of instruction for agents “C”, “N” and “S” as required.

It is intended that the various message logger agents operate in parallel.

Capture agent system/method 110A/210A comprises initialization steps 326 and 328 and loops between steps 329, 331, 333 and 334, Network agent system/method 110B/210B comprises initialization steps 336 and 338, and loops between steps 339, 341, 342 and 344, and Storm agent 110C/210C comprises initialization steps 346 and 349 and loops between steps 351, 353, 355, and 357.

The initialization steps for the agents are all similar. Database connection steps 326, 336 and 346 obtain a new database connection from the database connection pool. Initialization steps 328, 338, and 349, all retrieve the necessary configuration data from the configuration file, and start the execution of their respective message logger agent systems/methods.

The “loop” of message logger capture agent system/method 110A/210A includes a monitoring step 329 for monitoring all messages received on the parameters specified by the database settings, and extraction step 331 for extraction data from the message, including as a non-limiting example, message arrival time, subject, size, date, time and message source. Queuing step 333 stores this extracted data on a database queue until the queue is full, at which time database step 334 transfers the queued data to a database.

The “loop” of message logger network monitoring agent system/method 110B/210B includes a monitoring step 339 for monitoring all machine messages received on the parameters specified by the database settings, and extraction step 341 for extraction data from the message, including as a non-limiting example, messages sent/received, bytes sent/received, packets sent/received, packets missed, packets resent, messages retransmitted, messages dropped, IP address, host name, operating system, version, licensing file, uptime, service port, and network. Queuing step 342 stores this extracted data on a database queue until the queue is full, at which time database step 344 transfers the queued data to a database.

The “loop” of message logger network monitoring agent system/method 110C/210C includes a monitoring step 349 for monitoring all messages received on the parameters specified by the database settings. Analysis step 353 determines the message velocity, and optionally, any other items of interest, including message acceleration and statistical data. Signal generation step 355, generates a signal depending upon the value of the message velocity and a user defined threshold (or a number of thresholds), and optionally upon the message acceleration and any other desired parameters. Queuing step 355 stores any desired data on a database queue until the queue is full, at which time database step 357 transfers the queued data to a database.

Referring additionally to FIG. 6 there is provided a detailed process flowchart showing details for message logger new subject monitor 110E/210E, initialized in step 307. Last record step 364 locates the last record in the daily database and stores the address of that record in memory. Scanning step 369 scans the database starting at the last record address value for the existence of new software applications. Comparison step 388 is to determine if the subject of the received message (for example software program application name) exists on the cached software application name list. If it exists (i.e., it is old), then the last record value is incremented and program flow goes back to scanning step 369. If it does not exist (i.e. it is new), then database steps 390 and 391 save the new subject to, respectively, the subject cached table and the new subject table, alert step 393 informing the system administrator, and then the last record value is incremented and program flow goes back to scanning step 369.

It should be understood that the message subject field is generally vendor defined, although it may sometime be user defined and/or modified, and contains information of interest, value or use. For example, the subject could contain the company name, user name, operating environment, source application, destination application, data base name, transaction type, and the like.

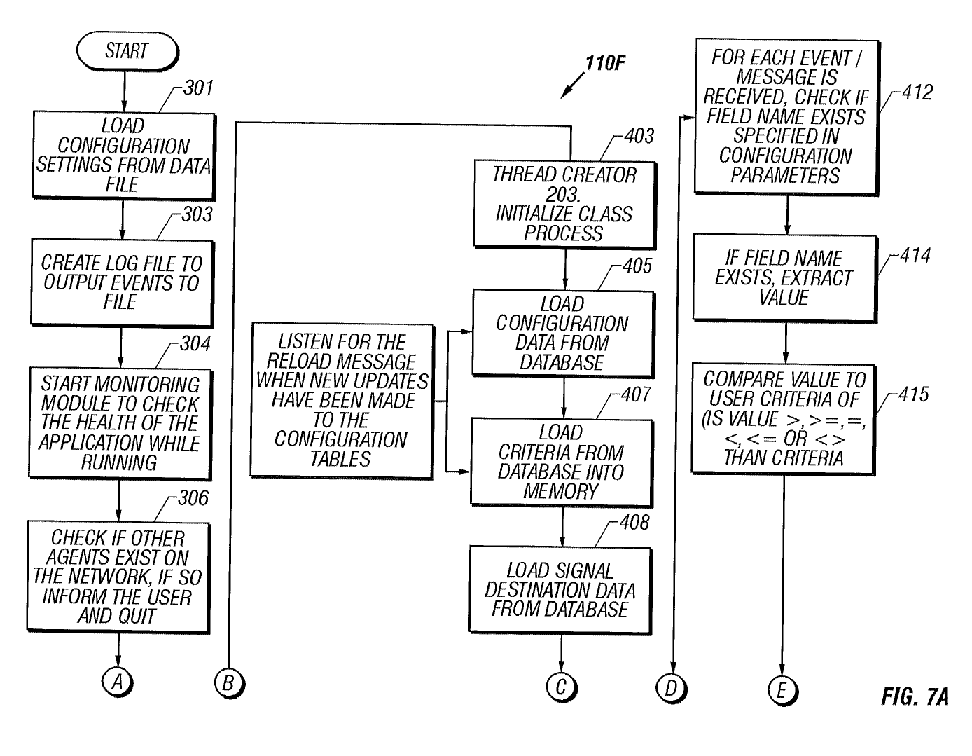

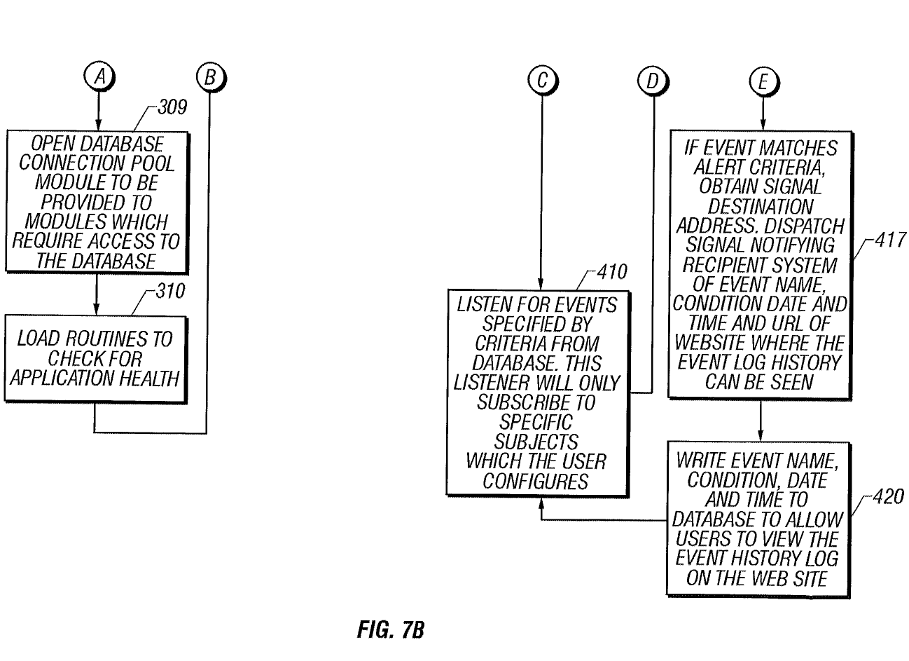

Referring additionally to FIG. 7 there is provided a detailed process flowchart showing details for message logger alert monitor system/method 110D/210D.

Initialization steps 301, 303, 304, 306, 309, and 310 have been described above.

Thread step 403 will create a new instance in memory of the agent instruction steps. Configuration step 405 reads the application parameters from the database, and will check the version of the message logger application against the version of the database. If the version doesn't match it informs the user and then quits. The content of the application table has been described above.

Alert step 407 will load various alerts or user defined rules from the alerts table, which could contain information such as, but not limited to: alert_name, alert_type, data field, data value, and recipient email or some address/location to which a signal will be sent). This agent is capable of performing the following tasks; it monitors messages and cross-references each message with its alert configuration data in memory looking for matches. If the agent detect a match, the agent identifies the alert type, which type can be DATA->Data contained in a message matches criteria.

Response step 408, loads destination data to which a signal will be sent when a message fits user provided criteria. This destination data could be, as non-limiting examples, an email address, pager number, or machine destination.

Monitoring step 410 using vendor specific API's listen for all messages on the network matching the criteria specified by the alert configuration settings.

For those messages matching the criteria, field name step 412 determines if the received message/event contains the specified field name specified in the configuration data. Extraction step 414 then extracts that field name value. Comparison step 415 then compares the value to user defined criteria (the following operators are valid to use: <.<=,>,>=,< >). Signal step 417 will as necessary generate a signal indicative of the comparison. In a preferred embodiment, signal step 417 will dispatch an email explaining the details of the alert encountered, and include in the message body of the email a URL, so that the recipient can click on the URL and be automatically transferred to the page containing all details regarding the alert.

Database step 420 stores any desired data on a database queue until the queue is full, at which time transfers the queued data to a database.

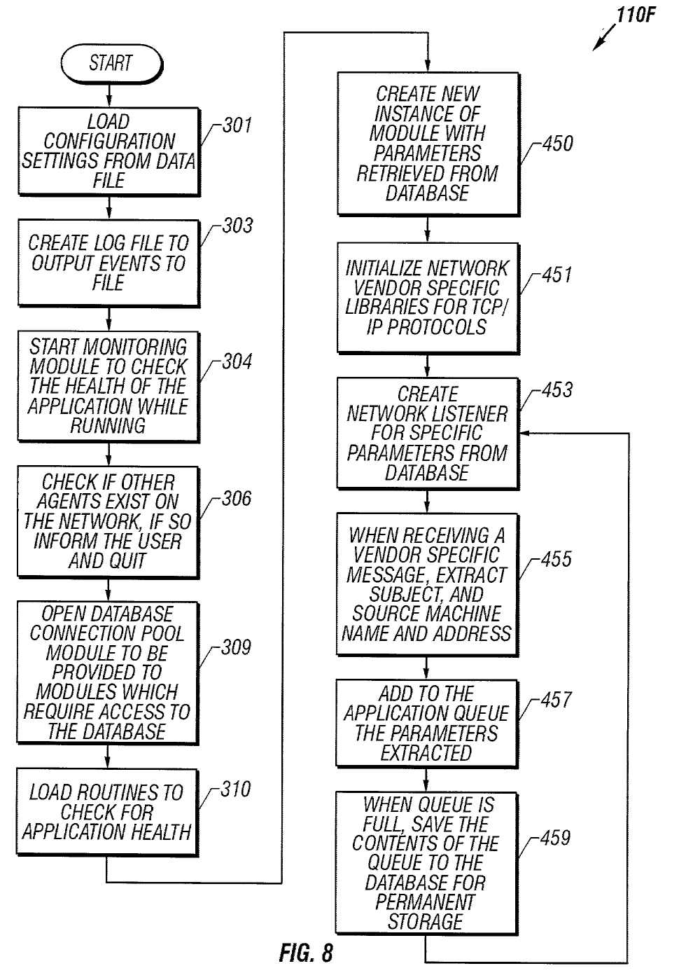

Referring additionally to FIG. 8 there is provided a detailed process flowchart showing details for message logger message tracker system/method 110F/210F.

Initialization steps 301, 303, 304, 306, 309, and 310 have been described above.

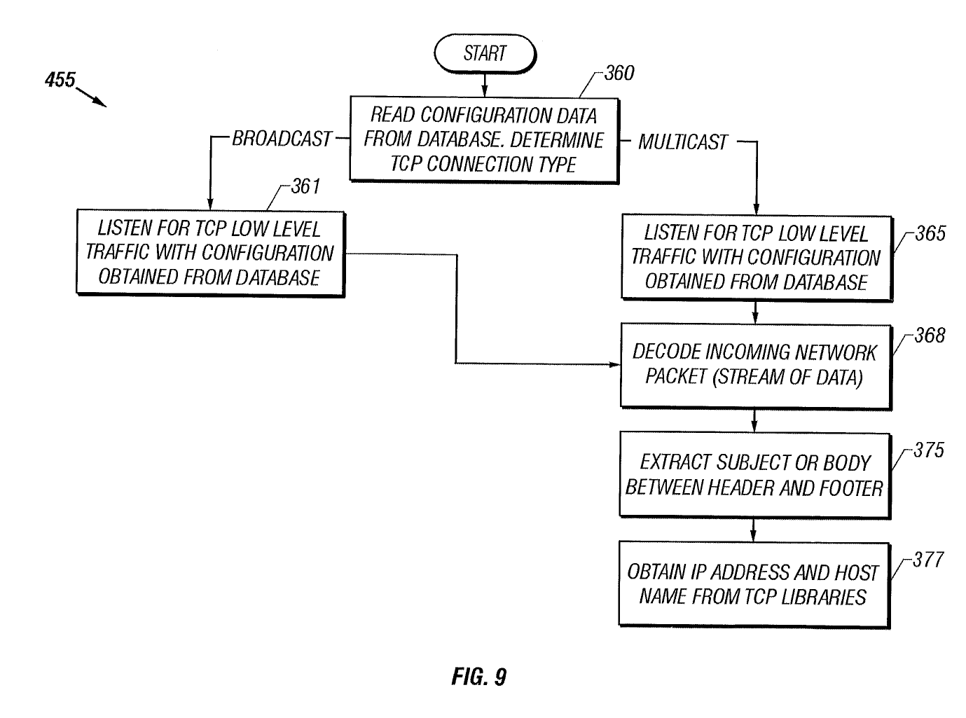

Thread step 440 will create a new instance in memory of the message tracker agent instruction steps. Library step 451 obtains vendor specific API's and other network software libraries in order to initialize the agent. Monitoring step 453 listens for vendor specific messages from parameters obtained from the configuration file. Extraction step 455 (described in detail in FIG. 9 below), extract the subject, date, time, machine address and host name. Queuing step 457 stores any desired data on a database queue until the queue is full, at which time database step 459 transfers the queued data to a database.

Referring now to FIG. 9, there is provided a detailed process flowchart for extraction step 455 of FIG. 8.

Type step 360 determines from the configuration data whether the TCP connection type is “broadcast” or is “multicast,” because different listening routines must be utilized. Specifically, when the listener listens for broadcast network traffic it utilizes only one parameter to begin listening, the “port number” (ie. TCP port 1540). When the listener listens for multicast network traffic, it requires two (2) parameters to begin listening, the “port number”, and “network multicast group” (i.e. 224.1.1.1). If the TCP connection type is “broadcast,” then listening step 361 is utilized, using the “port number.” If the TCP connection type is “multicast” then listening step 365 is utilized, using both “port number” and “network multicast group.” Listening steps 361 and 365 are generally carried out using a network software tool called a “sniffer.”

A message will consist of a header, the message, and a footer, with the header and footer collectively referred to as the wrapper. The message consists of the subject name and IP address. Decoder step 368 determines the header and footer values. Because the header and the footer are consistently repeating in the data stream, trial-and-error techniques are suitable for determining the header and footer values. Some vendors utilize more than one header and/or footer. Thus, some messages will have one header, and other messages will have another header (the same is true of footers). Extraction step 375 extracts the message from between the header and footer (but subtracting the header and footer from the data). Address step 377 obtains the IP address and host name from the TCP libraries.

The present invention will also include software to analyze the Messaging data, and provide statistical analysis of such data. While any suitable software may be utilized to provide this statistical analysis, most conveniently, a commercially available database management system will be utilized, such as Microsoft ACCESS, or Corel PARADOX. For example, historical data could be used to predict messaging velocity for a particular user, or software application, and quickly determine if the addition of that user or application will cause system problems, and generate a suitable signal.

It should be understood that the present invention may be used for messaging data for any desired subset of the overall network, such as but not limited to, all messages, all machine specific messages, all messages for a particular machine, all software application messages (including being version specific), all messages for a particular IP address, or for a particular user.

The product of the present invention includes computer readable media comprising instructions, or a data signal embodied in a carrier wave comprising instructions, said instructions which when carried out on a computer will implement one or more of the method steps of the present invention.

Using the foregoing specification, part or all of the present invention may be implemented using standard programming and/or engineering techniques using computer programming software, firmware, hardware or any combination or subcombination thereof. Any such resulting program(s), having computer readable program code means, may be embodied or provided within one or more computer readable or usable media such as fixed (hard) drives, disk, diskettes, optical disks, magnetic tape, semiconductor memories such as read-only memory (ROM), etc., or any transmitting/receiving medium such as the Internet or other communication network or link, thereby making a computer program product, i.e., an article of manufacture, according to the invention. The article of manufacture containing the computer programming code may be made and/or used by executing the code directly from one medium, by copying the code from one medium to another medium, or by transmitting the code over a network.

The apparatus of the present invention may be one or more processing systems including, but not limited to, a central processing unit (CPU), memory, storage devices, communication links, communication devices, servers, I/O devices, or any subcomponents or individual parts of one or more processing systems, including software, firmware, hardware or any combination or subcombination thereof, which embody the invention as set forth in the claims. User input may be received from the keyboard, mouse, pen, voice, touch screen, or any other means by which a human can input data to a computer, including through other programs such as application programs. One skilled in the art of computer science will easily be able to combine the software created as described with appropriate general purpose or special purpose computer hardware to create a computer system and/or computer subcomponents embodying the invention and to create a computer system and/or computer subcomponents for carrying out the method of the invention.

The present invention is believed to find utility with any type of software application that utilizes API's, and is not to be limited to any of the specific software examples shown herein.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which this invention pertains.

I claim:

1. A method for monitoring a computer network comprising at least two computers in communication with each other, and with each computer executing at least one software program publishing messages, the method comprises:
(A) counting, starting at a first time, messages published in a first time period to provide a first count; and
(B) comparing the first count to signaling criteria.

2. The method of claim 1, further comprising
(C) generating a signal dependant on the comparing of step (B).

3. The method of claim 2, wherein the signal comprises at least one selected from the group of a communication to a user in the form of an email, a screen display, a page, or a voice mail, a communication to a software program in the form of a message, an email, an API Method Call, and a communication to a hardware in the form of a Message, an API Method Call, or Simple Network Management Protocol.

4. The method of claim 1, wherein in step (A) only a certain criteria of messages are counted.

5. The method of claim 1, further comprising:
(C) counting, starting at a second time different than the first time, messages published in a second time period, the same or different than the first time period, to provide a second count; and
(D) determining an acceleration that is equal to the ((second count/second time period)−(first count/first time period))/(second time-first time).

6. The method of claim 5 further comprising:
(E) generating a signal dependant on at least one of the second count, the acceleration, and the threshold value.

7. The method of claim 5 further comprising:
(E) predicting a future count using at least one of the first count, the second count and the acceleration.

8. A system for gathering data from a computer network comprising at least two computers in communication with each other, and with each computer executing at least one software program publishing messages, the system comprising a computer in communication with the network and comprising software that when executed instruct the system to:
(A) count, starting at a first time, messages published in a first time period to provide a first count; and
(B) compare the first count to signaling criteria.

9. The system of claim 8, further comprising instructions that when executed by a computer instruct the computer to:
(C) generate a signal dependant on the comparing of step (B).

10. The system of claim 9, wherein the signal comprises at least one selected from the group of a communication to a user in the form of an email, a screen display, a page, or a voice mail, a communication to a software program in the form of a message, an email, an API Method Call, and a communication to a hardware in the form of a Message, an API Method Call, or Simple Network Management Protocol.

11. The system of claim 8, wherein in step (A) only a certain criteria of messages are counted.

12. The system of claim 8, further comprising instructions that when executed by a computer instruct the computer to:
(C) count, starting at a second time different than the first time, messages published in a second time period, the same or different than the first time period, to provide a second count; and
(D) determine an acceleration that is equal to the ((second count/second time period)−(first count/first time period))/(second time-first time).

13. The system of claim 9, further comprising instructions that when executed by a computer instruct the computer to:
(E) generate a signal dependent on at least one of the second count, the acceleration, and the threshold value.

14. The system of claim 9, further comprising instructions that when executed by a computer instruct the computer to:
(E) predict a future count using at least one of the first count, the second count and the acceleration.

15. A computer-readable storage medium having stored thereon a plurality of instructions for gathering data from a computer network comprising at least two computers in communication with each other, and with each computer executing at least one software program publishing messages, said instructions that when executed by a computer instruct the computer to:
(A) count, starting at a first time, messages published in a first time period to provide a first count; and
(B) compare the first count to signaling criteria.

16. The medium of claim 15, further comprising instructions that when executed by a computer instruct the computer to:
(C) generate a signal dependant on the comparing of step (B).

17. The medium of claim 16, wherein the signal comprises at least one selected from the group of a communication to a user in the form of an email, a screen display, a page, or a voice mail, a communication to a software program in the form of a message, an email, an API Method Call, and a communication to a hardware in the form of a Message, an API Method Call, or Simple Network Management Protocol.

18. The medium of claim 15, wherein in step (A) only a certain criteria of messages are counted.

19. The medium of claim 15, further comprising instructions that when executed by a computer instruct the computer to:
(C) count, starting at a second time different than the first time, messages published in a second time period, the same or different than the first time period, to provide a second count; and
(D) determine an acceleration that is equal to the ((second count/second time period)−(first count/first time period))/(second time-first time).

20. The medium of claim 16, further comprising instructions that when executed by a computer instruct the computer to:
(E) generate a signal dependant on at least one of the second count, the acceleration, and the threshold value.

21. The medium of claim 16, further comprising instructions that when executed by a computer instruct the computer to:
(E) predict a future count using at least one of the first count, the second count and the acceleration.

22. A propagated signal comprising a plurality of instructions for gathering data from a computer network comprising at least two computers in communication with each other, and with each computer executing at least one software program publishing messages, said instructions that when executed by a computer instruct the computer to:
(A) count, starting at a first time, messages published in a first time period to provide a first count; and
(B) compare the first count to signaling criteria.

23. The propagated signal of claim 22, further comprising instructions that when executed by a computer instruct the computer to:
(C) generate a signal dependant on the comparing of step (B).

24. The propagated signal of claim 23, wherein the signal comprises at least one selected from the group of a communication to a user in the form of an email, a screen display, a page, or a voice mail, a communication to a software program in the form of a message, an email, an API Method Call, and a communication to a hardware in the form of a Message, an API Method Call, or Simple Network Management Protocol.

25. The propagated signal of claim 22, wherein in step (A) only a certain criteria of messages are counted.

26. The propagated signal of claim 22, further comprising instructions that when executed by a computer instruct the computer to:
(C) count, starting at a second time different than the first time, messages published in a second time period, the same or different than the first time period, to provide a second count; and
(D) determine an acceleration that is equal to the ((second count/second time period)−(first count/first time period))/(second time-first time).

27. The propagated signal of claim 26, further comprising instructions that when executed by a computer instruct the computer to:
(E) generate a signal dependant on at least one of the second count, the acceleration, and the threshold value.

28. The propagated signal of claim 26, further comprising instructions that when executed by a computer instruct the computer to:
(E) predict a future count using at least one of the first count, the second count and the acceleration.

29. A method for gathering data from a computer network comprising at least two computers in communication with each other, and with each computer executing at least one software program publishing messages, the method comprises:
(A) monitoring the messages;
(B) comparing the messages to signaling criteria; and
(C) generating a signal dependent upon the comparing of step (B).

30. The method of claim 29, wherein in step (A) only a certain criteria of messages are monitored.

31. The method of claim 29, wherein the signal comprises at least one selected from the group of a communication to a user in the form of an email, a screen display, a page, or a voice mail, a communication to a software program in the form of a message, an email, an API Method Call, and a communication to a hardware in the form of a Message, an API Method Call, or Simple Network Management Protocol.

32. The method of claim 21, wherein the criteria is derived from historical message data.

33. A system for gathering data from a computer network comprising at least two computers in communication with each other, and with each computer executing at least one software program publishing messages, the system comprising a computer in communication with the network and comprising software that when executed instruct the system to:
(A) monitor the messages;
(B) compare the messages to signaling criteria; and
(C) generate a signal dependent upon the comparing of step (B).

34. The system of claim 33, wherein in (A) only a certain criteria of messages are monitored.

35. The system of claim 33, wherein the signal comprises at least one selected from the group of a communication to a user in the form of an email, a screen display, a page, or a voice mail, a communication to a software program in the form of a message, an email, an API Method Call, and a communication to a hardware in the form of a Message, an API Method Call, or Simple Network Management Protocol.

36. The system of claim 33, wherein the criteria is derived from historical message data.

37. A computer-readable storage medium having stored thereon a plurality of instructions for gathering data from a computer network comprising at least two computers in communication with each other, and with each computer executing at least one software program publishing messages, said instructions that when executed by a computer instruct the computer to:
(A) monitor the messages;
(B) compare the messages to signaling criteria; and
(C) generate a signal dependent upon the comparing of step (B).

38. The medium of claim 37, wherein in (A) only a certain criteria of messages are monitored.

39. The medium of claim 37, wherein the signal comprises at least one selected from the group of a communication to a user in the form of an email, a screen display, a page, or a voice mail, a communication to a software program in the form of a message, an email, an API Method Call, and a communication to a hardware in the form of a Message, an API Method Call, or Simple Network Management Protocol.

40. The medium of claim 37, wherein the criteria is derived from historical message data.

41. A propagated signal comprising a plurality of instructions for gathering data from a computer network comprising at least two computers in communication with each other, and with each computer executing at least one software program publishing messages, said instructions that when executed by a computer instruct the computer to:
(A) monitor the messages;
(B) compare the messages to signaling criteria; and
(C) generate a signal dependent upon the comparing of step (B).

42. The propagaged signal of claim 41, wherein in (A) only a certain criteria of messages are monitored.

43. The propagaged signal of claim 41, wherein the signal comprises at least one selected from the group of a communication to a user in the form of an email, a screen display, a page, or a voice mail, a communication to a software program in the form of a message, an email, an API Method Call, and a communication to a hardware in the form of a Message, an API Method Call, or Simple Network Management Protocol.

44. The propagaged signal of claim 41, wherein the criteria is derived from historical message data.

45. A method for gathering data from a computer network comprising at least two computers in communication with each other, and with each computer executing at least one software program publishing machine specific messages, the method comprises:
(A) monitoring the machine specific messages; and
(B) extracting data from the messages.

46. The method of claim 45, wherein in step (A) only a certain criteria of messages are monitored.

47. The method of claim 45 further comprising:
(C) comparing the data to criteria; and
(D) generating a signal dependent upon the comparing of step (C).

48. The method of claim 47, wherein the signal comprises at least one selected from the group of a communication to a user in the form of an email, a screen display, a page, or a voice mail, a communication to a software program in the form of a message, an email, an API Method Call, and a communication to a hardware in the form of a Message, an API Method Call, or Simple Network Management Protocol.

49. A system for gathering data from a computer network comprising at least two computers in communication with each other, and with each computer executing at least one software program publishing messages, the system comprising a computer in communication with the network and comprising software that when executed instruct the system to:
(A) monitor the machine specific messages; and
(B) extract data from the messages.

50. The system of claim 49, wherein in (A) only a certain criteria of messages are monitored.

51. The system of claim 49, further comprising:
(C) compare the data to criteria; and
(D) generate a signal dependent upon the comparing of step (C).

52. The system of claim 51, wherein the signal comprises at least one selected from the group of a communication to a user in the form of an email, a screen display, a page, or a voice mail, a communication to a software program in the form of a message, an email, an API Method Call, and a communication to a hardware in the form of a Message, an API Method Call, or Simple Network Management Protocol.

53. A computer-readable storage medium having stored thereon a plurality of instructions for gathering data from a computer network comprising at least two computers in communication with each other, and with each computer executing at least one software program publishing messages, said instructions that when executed by a computer instruct the computer to:
(A) monitor the machine specific messages; and
(B) extract data from the messages.

54. The medium of claim 53, wherein in (A) only a certain criteria of messages are monitored.

55. The medium of claim 53, further comprising:
(C) compare the data to criteria; and
(D) generate a signal dependent upon the comparing of step (C).

56. The medium of claim 55, wherein the signal comprises at least one selected from the group of a communication to a user in the form of an email, a screen display, a page, or a voice mail, a communication to a software program in the form of a message, an email, an API Method Call, and a communication to a hardware in the form of a Message, an API Method Call, or Simple Network Management Protocol.

57. A propagated signal comprising a plurality of instructions for gathering data from a computer network comprising at least two computers in communication with each other, and with each computer executing at least one software program publishing messages, said instructions that when executed by a computer instruct the computer to:
(A) monitor the machine specific messages; and
(B) extract data from the messages.

58. The propagated signal of claim 57, wherein in (A) only a certain criteria of messages are monitored.

59. The propagated signal of claim 57, further comprising:
(C) compare the data to criteria; and
(D) generate a signal dependent upon the comparing of step (C).

60. The propagated signal of claim 59, wherein the signal comprises at least one selected from the group of a communication to a user in the form of an email, a screen display, a page, or a voice mail, a communication to a software program in the form of a message, an email, an API Method Call, and a communication to a hardware in the form of a Message, an API Method Call, or Simple Network Management Protocol.

61. A method for gathering data from a computer network comprising at least two computers in communication with each other, and with each computer executing at least one software program publishing messages having a subject field, the method comprises:
(A) monitoring the messages;
(B) if the message subject field already exists in a current listing of subjects, then return to step (A); and
(C) if the message subject does not exist in the listing of subject, then add the message subject to the listing, and then return to step (A).

62. The method signal of claim 61, wherein in (A) only a certain criteria of messages are monitored.

63. A system for gathering data from a computer network comprising at least two computers in communication with each other, and with each computer executing at least one software program publishing messages, the system comprising a computer in communication with the network and comprising software that when executed instruct the system to:
(A) monitor the messages;
(B) determine if the message subject field already exists in a current listing of subjects, and if so then return to (A); and
(C) determine if the message subject does not exist in the listing of subject, and if not, then add the message subject to the listing, and then return to step (A).

64. The system of claim 63, wherein in (A) only a certain criteria of messages are monitored.

65. A computer-readable storage medium having stored thereon a plurality of instructions for gathering data from a computer network comprising at least two computers in communication with each other, and with each computer executing at least one software program publishing messages, said instructions that when executed by a computer instruct the computer to:
(A) monitor the messages;
(B) determine if the message subject field already exists in a current listing of subjects, and if so then return to (A); and
(C) determine if the message subject does not exist in the listing of subject, and if not, then add the message subject to the listing, and then return to step (A).

66. The medium of claim 65, wherein in (A) only a certain criteria of messages are monitored.

67. A propagated signal comprising a plurality of instructions for gathering data from a computer network comprising at least two computers in communication with each other, and with each computer executing at least one software program publishing messages, said instructions that when executed by a computer instruct the computer to:
(A) monitor the messages;
(B) determine if the message subject field already exists in a current listing of subjects, and if so then return to (A); and
(C) determine if the message subject does not exist in the listing of subject, and if not, then add the message subject to the listing, and then return to step (A).

68. The propagated signal of claim 67, wherein in (A) only a certain criteria of messages are monitored.

69. A method for gathering data from a computer network comprising at least two computers in communication with each other, and with each computer executing at least one software program publishing messages, the method comprises:
(A) monitoring a message coming from a messaging computer; and
(B) identifying the messaging computer.

70. The method of claim 69, wherein step (B) comprises the steps of (i) determining a message header; (ii) determining a message footer; and (iii) subtracting the header and footer from the message to provide the messaging computer.

71. A system for gathering data from a computer network comprising at least two computers in communication with each other, and with each computer executing at least one software program publishing messages, the system comprising a computer in communication with the network and comprising software that when executed instruct the system to:
(A) monitor a message coming from a messaging computer; and
(B) identify the messaging computer.

72. The system of claim 71, wherein (B) comprises software that when executed instruct the system to (i) determine a message header; (ii) determine a message footer; and (iii) subtract the header and footer from the message to provide the messaging computer.

73. A computer-readable storage medium having stored thereon a plurality of instructions for gathering data from a computer network comprising at least two computers in communication with each other, and with each computer executing at least one software program publishing messages, said instructions that when executed by a computer instruct the computer to:
(A) monitor a message coming from a messaging computer; and
(B) identify the messaging computer.

74. The medium of claim 73, wherein (B) comprises software that when executed instruct the system to (i) determine a message header; (ii) determine a message footer; and (iii) subtract the header and footer from the message to provide the messaging computer.

75. A propagated signal comprising a plurality of instructions for gathering data from a computer network comprising at least two computers in communication with each other, and with each computer executing at least one software program publishing messages, said instructions that when executed by a computer instruct the computer to:
(A) monitor a message coming from a messaging computer; and
(B) identify the messaging computer.

76. The propagated signal of claim 75, wherein (B) comprises software that when executed instruct the system to (i) determine a message header; (ii) determine a message footer; and (iii) subtract the header and footer from the message to provide the messaging computer.
